(19) United States
(12) Patent Application Publication
(10) Pub. No.: US 2021/0114396 A1
(43) Pub. Date: Apr. 22, 2021

(54) Identification Card Having Transparent Light-Conducting Core

(71) Applicant: VALID USA, INC., Hillside, IL (US)

(72) Inventor: Richard Westenfeld, Fort Wayne, IN (US)

(21) Appl. No.: 17/002,455

(22) Filed: Aug. 25, 2020

Related U.S. Application Data
(60) Provisional application No. 62/924,641, filed on Oct. 22, 2019.

(51) Int. Cl. B42D 25/23; B42D 25/351; B32B 27/08

(52) U.S. Cl. CPC B42D 25/23; B42D 25/387; B32B 27/08; B42D 25/351

(57) ABSTRACT

A multi-layered identification card includes a light-conducting core layer. When the multi-layered identification card is exposed to an activated coherent light source, such as a bright white light or a laser, a perimeter of the light-conducting core layer illuminates. Selectively visible images and/or selectively visible text may be provided on or in one or more layers of the multi-layered identification card, which features become visible upon activation of the light source through one or more opaque layers of the identification card. A method for verifying the authenticity of a multi-layered identification card includes exposing the light-conducting core layer of the identification card to a light source, activating the light source, and observing the illuminated exposed portion of the perimeter of the light-conducting core.

### CROSS-REFERENCE TO RELATED APPLICATION

This is the non-provisional, and claims the benefit of the filing date under 35 USC § 119(e), of U.S. Provisional Application No. 62/924,641, filed Oct. 22, 2019, the entirety of which is hereby incorporated by reference.

### FIELD OF THE DISCLOSURE

This disclosure relates generally to security features of identification cards and, more specifically, to identification cards employing one or more light-conducting layers to facilitate verification of card authenticity, and selectively-visible features that are only visible when a coherent light is brought into communication with a perimeter of the identification card.

### BACKGROUND AND SUMMARY OF THE DISCLOSURE

With the proliferation of desktop publishing tools and increased resolution of smartphone cameras and scanners, it is increasingly challenging to prevent the production of counterfeit identification cards. Even embedded security features such as holograms can be fraudulently emulated by determined counterfeiters. In developing security features into identification cards that are resistant to these increasingly-accessible technologies, it is desirable to develop security features that are intuitive to detect for purposes of readily verifying card authenticity. Identity card verification by transportation security administration personnel, police and other law enforcement officers, private security personnel, bartenders, alcohol and tobacco/vape product merchants, department of motor vehicles employees, examination administrators, and others having a need to verify one's identity or age, require easy, intuitive methodologies for verifying the authenticity of an identification card.

Identification cards of the present disclosure employ a transparent or translucent, light-conducting core sandwiched between opaque card layers. As used herein, an “opaque card layer” refers to a card layer made of a material that appears to be impenetrable to light in typical indoor or outdoor ambient lighting conditions or that absorbs most visible light, though inks that reflect coherent light, and/or inks that are excited upon exposure to radiation, such as UV-activated inks, are visible through such an opaque card layer when exposed to an actuated light source, as described in more detail below. Also as used herein, “transparent card layer” is not intended to be limited to a card layer that is perfectly, or entirely, clear, but rather, is intended to convey that light can be transmitted, diffracted, or diffused through the card layer, and may be uncolored or colored. Each of the opaque card layers is covered by a respective clear outer protective layer. In one embodiment, the light conducting transparent or translucent core, which extends to the outer perimeter of the identification card, permits the entire perimeter of the core, or at least an exposed portion of the perimeter of the core in the event less than the entire perimeter of the core is exposed, to illuminate when an activated light source, preferably a high intensity, coherent light or a laser, is brought into close proximity to any portion of the perimeter of the identification card.

In another embodiment, a selectively-visible image, such as a picture of an object, text, or both, is printed on an internal surface of an opaque card layer, or on one or more surfaces of, or embedded within, a transparent or translucent core layer of the identification card. While obscured from view by the opaque card layers in the absence of an activated light source, once the light source is applied, the selectively-visible image becomes visible through at least one of the opaque card layers. In this embodiment, provided the clear core extends to the outer perimeter of the identification card as in the previous embodiment, in addition to the selectively-visible image becoming visible, the entire perimeter of the core, or the exposed portion of the perimeter of the core if less than an entire perimeter of the core layer is exposed to the edge of the identification card, also illuminates when the activated coherent light source is brought into close proximity to any portion of the perimeter of the identification card.

In yet another embodiment, as in the other embodiments, an identification card employs a transparent or translucent, light-conducting core sandwiched between opaque card layers, each of which is covered by a respective clear outer protective layer. One or both of the opaque card layers is provided with an image defined by a multiplicity of perforations, such as a picture of an object, text, or both. Upon bringing an activated light source into close proximity with any portion of the perimeter of the identification card, not only does the entire perimeter of the core illuminate, but also, light passes through the perforations forming the image, making that image visible on the opaque layer(s) of the card in which the perforations are provided.

In order to absorb light in planes outside of the light-conducting core layer, a conical baffle provided with a slit of adequate thickness to accommodate the thickness of the identification card, is preferably secured to a coherent light source, such as a laser.

### BRIEF DESCRIPTION OF THE SEVERAL VIEWS OF THE DRAWINGS

FIG. 1 is a perspective view of an identification card of the present disclosure;

FIG. 2 is an exploded view of an identification card of a first embodiment of the present disclosure;

FIG. 3 is an exploded view of an identification card of a second embodiment of the present disclosure;

FIG. 4 is a perspective view of the identification card of FIG. 3, received in a slot of a baffle provided on a light source, the light source being in an inactive state;

FIG. 5 is a perspective view of the identification card of FIG. 3, received in a slot of a baffle provided on a light source, the light source being in an activated state;

FIG. 6 is an exploded view of an identification card of a third embodiment of the present disclosure, in combination with a light source having a baffle thereon;

FIG. 7 is a perspective view of the identification card of FIG. 6, received in a slot of a baffle provided on a light source, the light source being in an inactive state;

FIG. 8 is a perspective view of the identification card of FIG. 6, received in a slot of a baffle provided on a light source, the light source being in an activated state; and

FIG. 9 is an enlarged perspective view of the region bounded by the broken-lined circle designated 9 in FIG. 5.

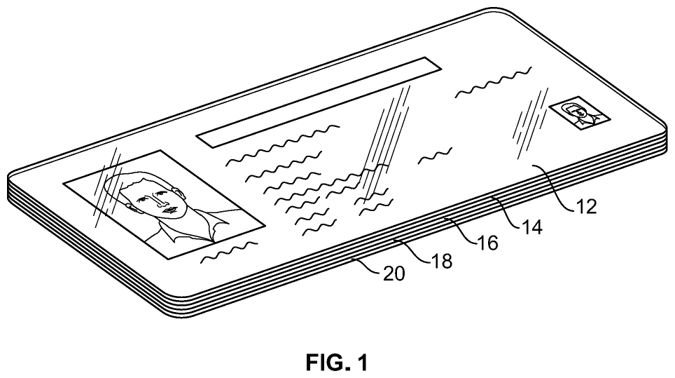

### DETAILED DESCRIPTION OF THE PREFERRED EMBODIMENTS

An identification card 10 of the present disclosure is made of multiple layers, including at least a first transparent outer layer 12 that serves as an outer, protective layer, a first opaque layer 14 underlying the first transparent outer layer 12, a transparent or translucent light-conducting core layer 16 underlying the first opaque layer 14, a second opaque layer 18 underlying the light-conducting core layer 16, and a second transparent outer layer 20 underlying the second opaque layer, the second transparent outer layer 20 serving as a second outer, protective layer. Adjacent layers of the multi-layered identification card 10 are adhered to one another in a conventional manner, such as by heat lamination. It is recognized that the first and second transparent outer layers 12, 20 are optional, and there may be additional layers intermediate one or both of the first and second opaque layers 14, 18 and the light-conducting core layer 16, or overlying the first and/or second transparent outer layers 12, 20, if present.

While the thickness and materials of the identification card 10 may vary, by way of example only, the first and second transparent outer layers 12 and 20 may each have a thickness of 4 mils and be made of a clear polycarbonate or other suitable transparent or translucent material. The first and second opaque layers 14 and 18 may each have a thickness of 6 mils and be made of an opaque material, such as a white polycarbonate, or other suitable material that appears to be impenetrable to light in typical indoor or outdoor ambient lighting conditions, though inks that reflect coherent light, and/or inks that are excited upon exposure to radiation, such as UV-activated inks, are visible through such a layer when exposed to an actuated light source. The light-conducting core layer 16 may have a thickness of 10 mils and be a clear polycarbonate or other suitable transparent or translucent material. The overall identification card may have a thickness of approximately 30 mils. Of course, the thickness of the light-conducting core layer 16 may be increased and the thicknesses of the first and second opaque layers 14, 18 may be decreased to maintain the overall thickness of 30 mils, but provide a light-conducting core layer 16 that produces a more dramatic perimeter lighting effect when the edge of the identification card is exposed to a coherent light.

A coherent light source, such as a laser light or other bright light source, is provided with a baffle having a slot therein of a width sufficient to receive the identification card 10. When the identification card 10 is placed in the slot and the light source is energized, at least an exposed portion of the perimeter of the light-conducting core layer 16 illuminates, thereby providing an indication of the validity of the identification card 10.

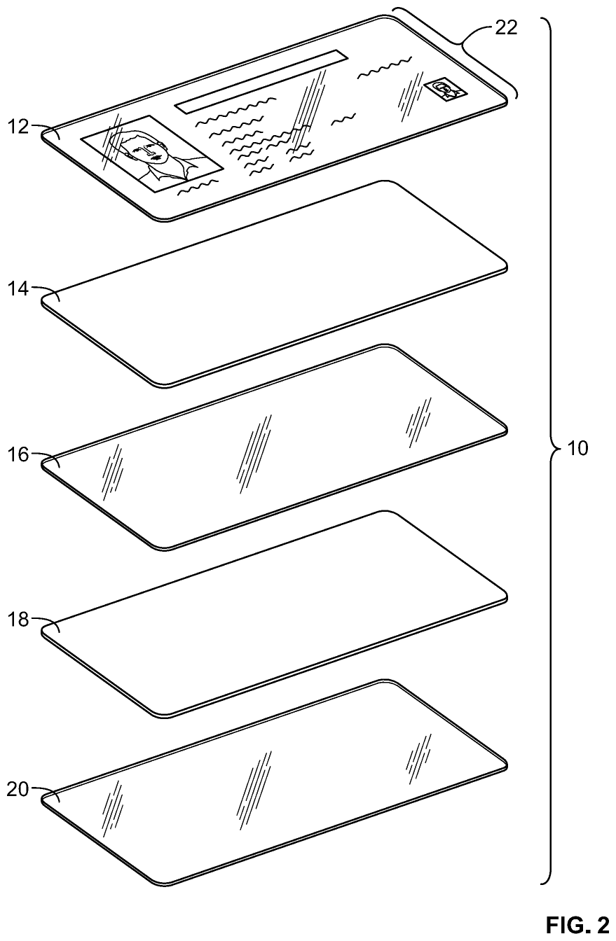

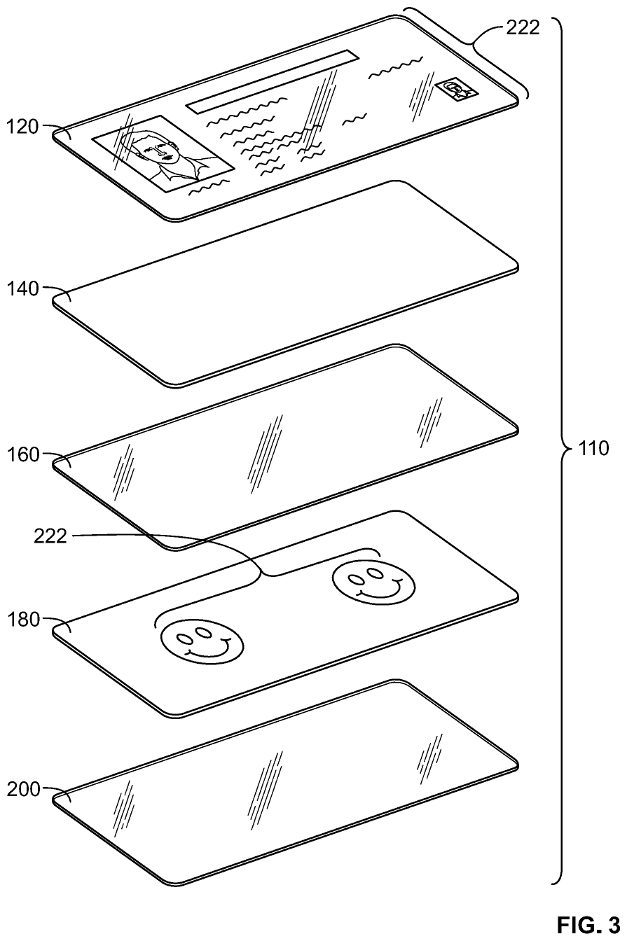

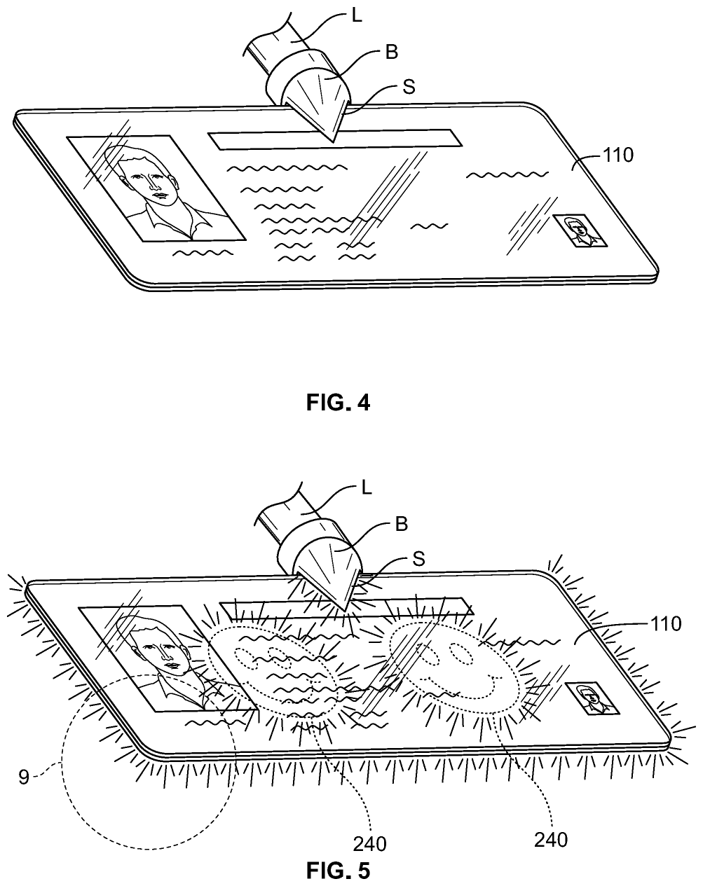

As illustrated in FIG. 2, conventional identifying indicia 22 typically associated with an identification card, such as the type of identification card, the issuing authority, and bibliographic personal information of the card barer, may be printed or engraved on one or both the first transparent outer layer 12 and the second transparent outer layer 20. According to a second embodiment, illustrated in FIGS. 3-5, an identification card 110 includes a first transparent outer layer 120, a first opaque layer 140, a transparent or translucent light-conducting core layer 160, a second opaque layer 180, and a second transparent outer layer 200. One or more selectively visible images 240 may be printed on an inside surface of the second opaque layer 180 facing the light-conducting core layer 160. Alternatively, or in addition, other selectively visible images (not shown) could be printed on an inside surface of the first opaque layer 140 or on either surface of, or within, the light-conducting core layer 160. Depending on the desired effect, two or more of these selectively visible images may be combined.

The identification card 110 may be received in a slot S of a baffle B of a coherent light source L, such as a bright light or laser. As illustrated in FIG. 5, upon activation of the light source L, not only does a perimeter of the light-conducting core layer 160 emit light, but also, the one or more selectively visible images 240, which are not visible through the first opaque layer 14 when the light source L is not activated, become visible.

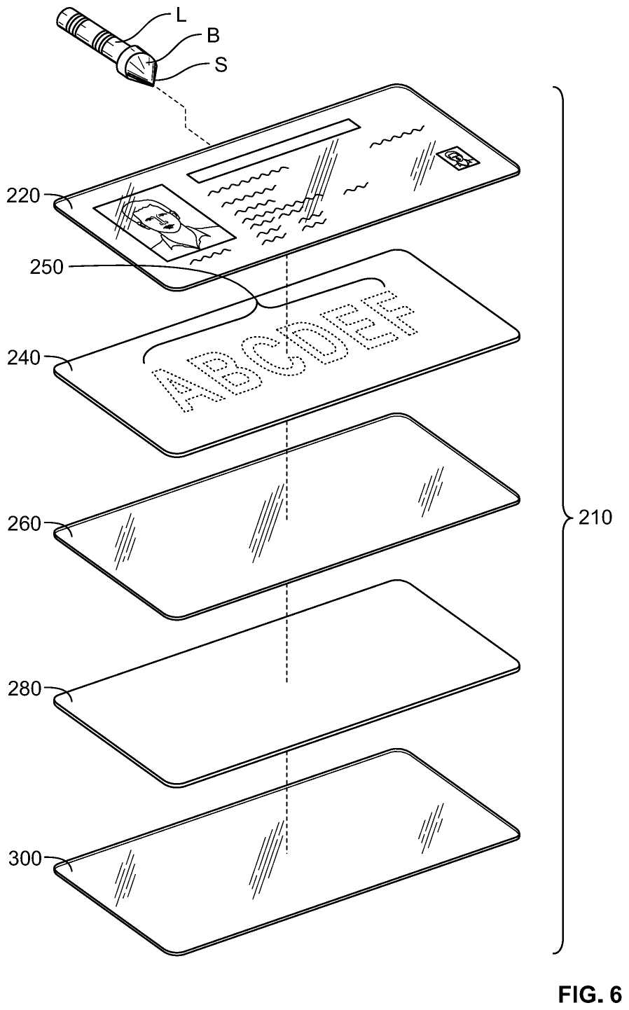

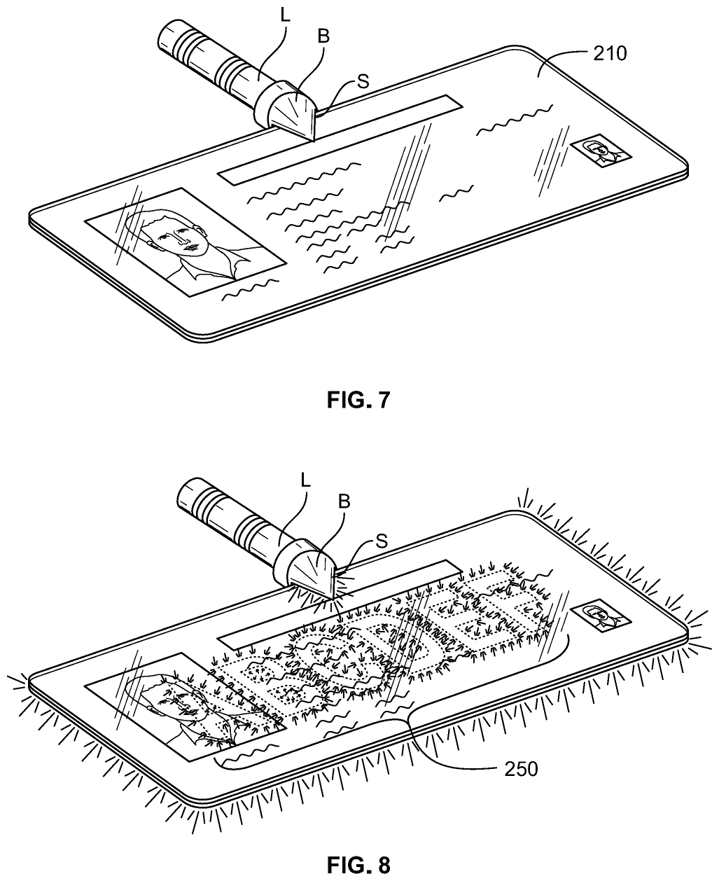

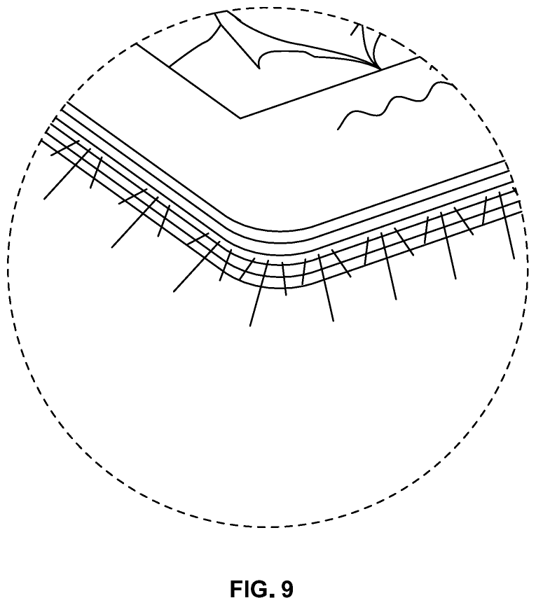

Turning to FIGS. 6-8, according to yet another embodiment, an identification card 210 is similarly provided with a first transparent layer 220, first opaque layer 240 a light-conducting core layer 260, a second opaque layer 280, and a second transparent layer 300. According to this embodiment, the first opaque layer 240 is provided with a selectively visible image and/or text 250 defined by a multiplicity of perforations through the opaque layer 240, which multiplicity of perforations may be imparted to the opaque layer 240 by laser drilling. While a variety of diameters of the perforation holes defining the selectively visible image and/or text 250 is possible, a test of perforation hole diameters of 0.012″, 0.025″, and 0.047″ was performed. While all holes of each of the three diameters illuminated upon activation of a light source L in the proximity of a perimeter of the light-conducting core layer 260 of the identification card 210, the 0.012″ holes were difficult to see. Therefore, the laser perforation holes are preferably greater in diameter than 0.012″. Each of the perforations defining the image and/or text 250 extends through the opaque layer 240, thereby exposing the light-conducting core layer 260 to the first transparent layer 220 which is opposite the first opaque layer 240 from the light-conducting core layer 260. The second opaque layer 280 may also, or alternatively, include one or more selectively visible images and/or text (not shown) defined by a multiplicity of perforations imparted to the opaque layer 280. If both opaque layers 240, 280 are perforated, the patterns may or may not overlap, depending upon the desired effect.

It is recognized that more than one of the security features disclosed herein may be combined in a single identification card, such as providing an identification card with both a selectively visible image printed on one or more of an inner surface of one of the opaque layers of the identification card or on the light-conducting core layer of the card, and also include a laser perforated selectively visible image and/or text in one or both of the opaque layers.

While the light source L may be a laser, it is recognized that less intense light sources may be more widely accessible to persons desiring to utilize the security features disclosed herein to verify the authenticity of an identification card. For example, the light-conducting inner core may be constructed using a transparent, colored plastic material which, when illuminated by bright white light, causes the exposed portion of the perimeter of the core layer of the card to glow in the core color. Alternatively, the light source L could be in the form of an ultraviolet (UV) light source if a UV pigment that emits visible light when exposed to UV light is dispersed into the light-conducting core layer, or is printed on a surface of the light-conducting core layer or on a surface of one of the opaque layers facing the light-conducting core layer. Similarly, an infrared (IR) light source can be used if an IR pigment is dispersed into the light-conducting core layer.

While certain embodiments have been described herein, it will be understood that variations to the above-described embodiments may be made that are still considered within the scope of the appended claims.

What is claimed is:

1. A multi-layered identification card comprising:
a first protective layer;
a first opaque layer underlying the protective layer;
a light-conducting core layer underlying the first opaque layer;
a second opaque layer underlying the light-conducting core layer; and
a second protective layer underlying the second opaque layer.

2. The multi-layered identification card of claim 1, further comprising indicia provided on at least one of the first protective layer, a surface of the first opaque layer facing the first protective layer, the second protective layer, or a surface of the second opaque layer facing the second protective layer.

3. The multi-layered identification card of claim 2, further comprising a selectively visible image printed on at least one of a surface of the first opaque layer facing the light-conducting core layer, the light-conducting core layer, or a surface of the second opaque layer facing the light-conducting core layer.

4. The multi-layered identification card of claim 2, wherein at least one of the first opaque layer or the second opaque layer is provided with at least one of a perforated image or perforated text defined by a multiplicity of perforations through the respective opaque layer, the perforations exposing the light-conducting core layer to the protective layer opposite that respective opaque layer from the light-conducting core layer.

5. The multi-layered identification card of claim 4, wherein each of the perforations has a diameter greater than 0.012″.

6. The multi-layered identification card of claim 1, received in a slot of a baffle, the slot of the baffle having a width greater than a thickness of the multi-layered identification card, the baffle received on a light source that, when activated, transmits light to the light-conducting core layer of the multi-layered card, while the baffle absorbs light from the light source in planes outside of the core layer of the multi-layered identification card.

7. The multi-layered identification card of claim 1, wherein the light-conducting layer has a thickness of 10 mils.

8. The multi-layered identification card of claim 1, wherein each of the layers is made of a polycarbonate.

9. The multi-layered identification card of claim 1, having an overall thickness of approximately 30 mils.

10. The multi-layered identification card of claim 1, further comprising a selectively viewable image printed on at least one of a surface of the first opaque layer facing the light-conducting core layer, the light-conducting core layer, or a surface of the second opaque layer facing the light-conducting core layer, the selectively viewable image being printed in a UV pigment that emits visible light when exposed to UV light.

11. The multi-layered identification card of claim 1, wherein the light-conducting core layer extends to a perimeter of the multi-layered identification card.

12. A method of verifying the authenticity of a multi-layered identification card, the multi-layered identification card including a first protective layer;
a first opaque layer underlying the first protective layer;
a light-conducting core layer underlying the first opaque layer;
a second opaque layer underlying the light-conducting core layer; and
a second protective layer underlying the second opaque layer, wherein at least a portion of the light-conducting core layer extends to a perimeter of the multi-layered identification card, the method comprising:
placing the multi-layered identification card into a slot of a slotted baffle provided on a light source;
activating the light source; and
observing whether light from the light source illuminates at least an exposed portion of a perimeter of the light-conducting core layer.

13. The method of claim 11, wherein the multi-layered identification card further includes a selectively visible image printed on at least one of a surface of the first opaque layer facing the light-conducting core layer, the light-conducting core layer, or a surface of the second opaque layer facing the light-conducting core layer, the method further comprising observing whether the selectively visible image is visible when the light source is activated and the multi-layered identification card is received in the slot of the slotted baffle.
